(19) United States
(12) Patent Application Publication
(10) Pub. No.: US 2025/0248786 A1
(43) Pub. Date: Aug. 7, 2025

(54) Disposable Toothbrush Arrangement

(71) Applicant: Julie Dammeier, Alta Loma, CA (US)

(72) Inventor: Julie Dammeier, Alta Loma, CA (US)

(21) Appl. No.: 18/434,428

(22) Filed: Feb. 6, 2024

(51) Int. Cl. A61C 3/00; A46B 11/00

(52) U.S. Cl. CPC A61C 3/005; A46B 11/0006; A46B 11/0096; A46B 11/0089

(57) ABSTRACT

A disposable toothbrush arrangement includes a brush body, a brush head, a brush neck, a pushing arrangement, and a twist knob. The brush neck and brush head includes channels therein to permit the flow of toothpaste into the brush head and out apertures therein. The pushing arrangement is positioned within the brush body and designed to exert a pushing force on the toothpaste. The twist knob is positioned at an end of the brush body and operatively connected to the pushing arrangement and designed to be twisted by a user to actuate the pushing arrangement and push toothpaste out through the head apertures. Once all toothpaste is used, the disposable toothbrush arrangement can be discarded and replaced.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to disposable toothbrushes and more particularly pertains to a new disposable toothbrush arrangement. For toothbrushes, there are several issues relating to their use. One is having a supply of toothpaste on hand when a person is traveling or located away from home, such as when serving in the military or working at a remote location. Another is knowing when to replace the toothbrush, as it is recommended to replace the toothbrush every three to four months and preferably no later than six months as the bristles can become worn and frayed and thus less effective at brushing away plaque and bacteria. Replacing the toothbrush can also be a problem when a person is traveling or located away from home.

### (2) Description of Related Art Including Information Disclosed Under 37 CFR 1.97 and 1.98

The prior art relates to disposable toothbrushes. The prior art, as best understood, does not disclose a disposable toothbrush with a built-in supply of toothpaste and a twist knob 20 pushing arrangement to advance the toothpaste out of the toothbrush head.

### BRIEF SUMMARY OF THE INVENTION

An embodiment of the disclosure meets the needs presented above in a disposable toothbrush arrangement that includes a brush body, a brush head, a brush neck, a pushing arrangement, and a twist knob. The brush body is designed to be gripped by a user. The brush head includes bristles for brushing the teeth of a user. The brush neck designed and positioned to connect the brush head to the brush body. The brush body includes a storage cavity therein designed to store toothpaste. The brush neck includes a neck channel therein to permit the flow of toothpaste therethrough. The brush head includes a head channel therein to permit the flow of toothpaste into the brush head. The brush head includes head apertures operatively connected to the head channel and designed and positioned to permit the flow of toothpaste to the bristles. The pushing arrangement is positioned within the brush body and designed to exert a pushing force on the toothpaste to thereby cause an amount of toothpaste to flow out through the head apertures. The twist knob is positioned at an end of the brush body and operatively connected to the pushing arrangement and designed to be twisted by a user to actuate the pushing arrangement.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a rear perspective view of a disposable toothbrush arrangement according to an embodiment of the disclosure.

FIG. 2 is a front perspective view of an embodiment of the disclosure.

FIG. 3 is a side view of an embodiment of the disclosure.

FIG. 4 is a cross-sectional view of an embodiment of the disclosure.

FIG. 5 is a close-up view of a portion of an embodiment of the disclosure.

FIG. 6 is a close-up view of a portion of an embodiment of the disclosure.

FIG. 7 is a perspective view of an embodiment of the disclosure.

FIG. 8 is a close-up view of a portion of an embodiment of the disclosure.

FIG. 9 is a side view of an embodiment of the disclosure in use.

### DETAILED DESCRIPTION OF THE INVENTION

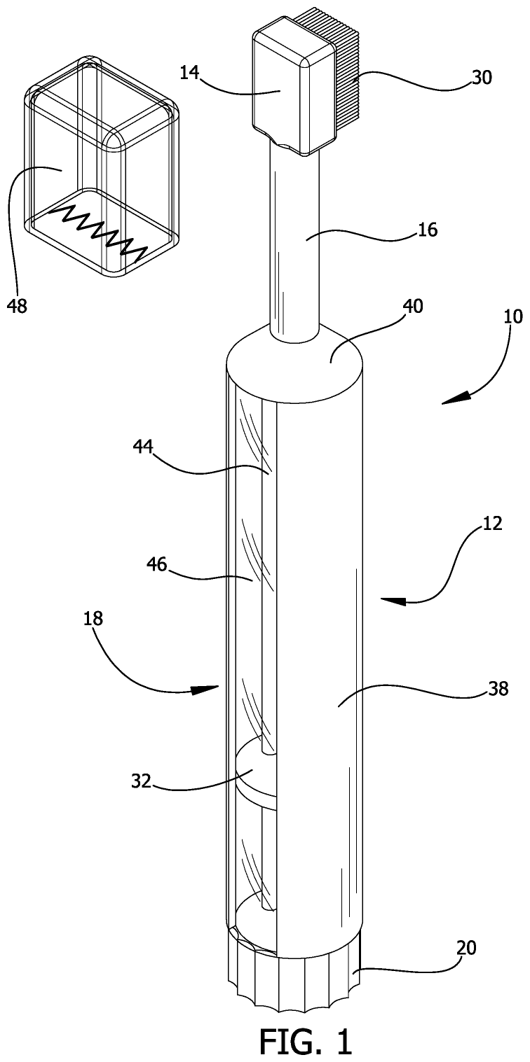

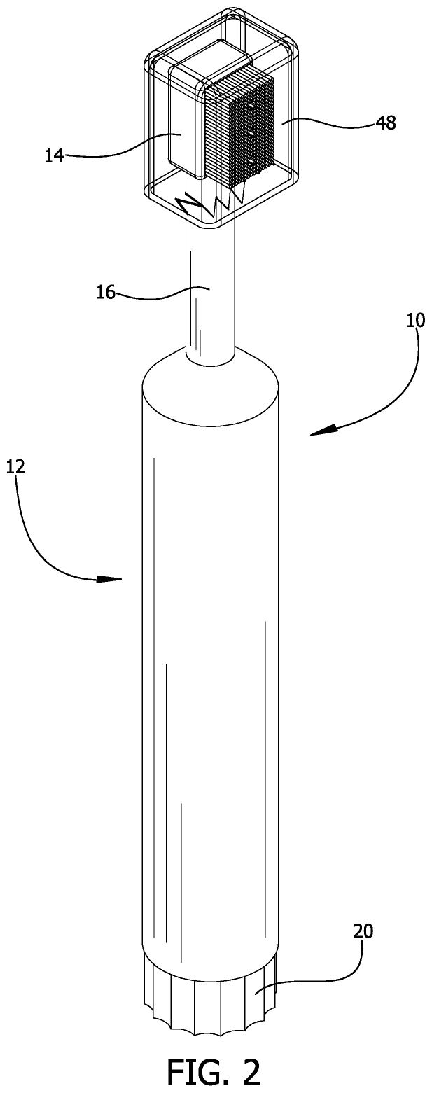

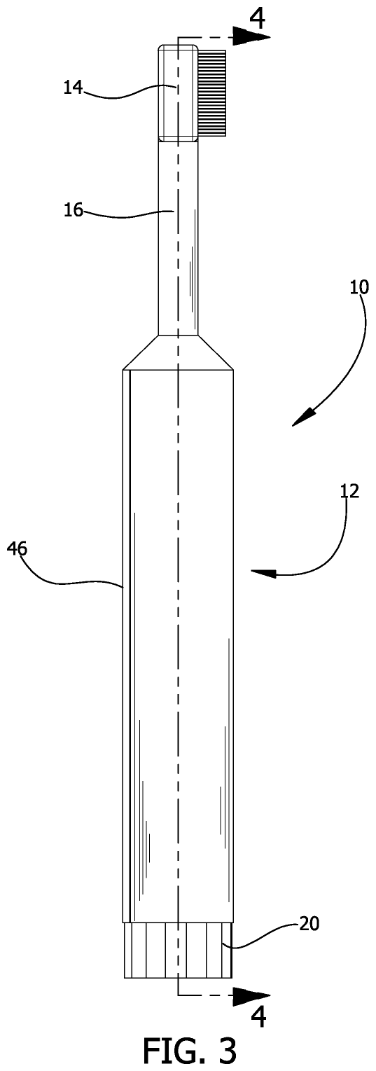

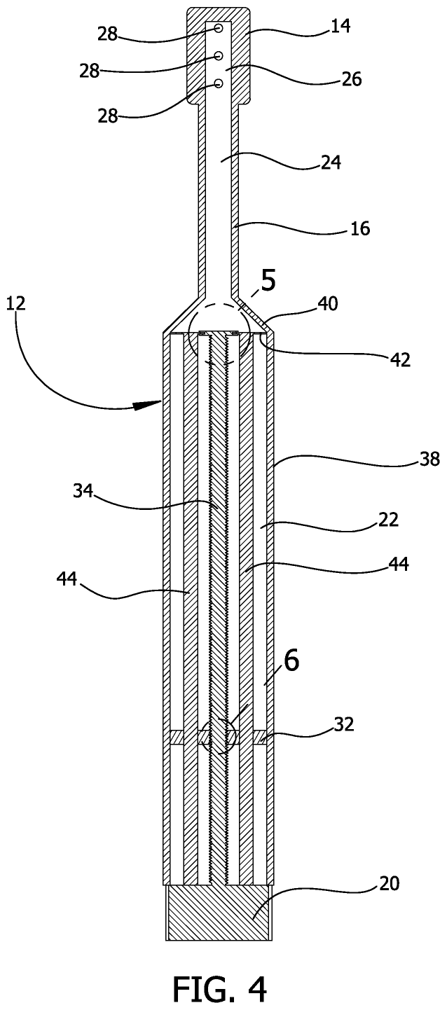

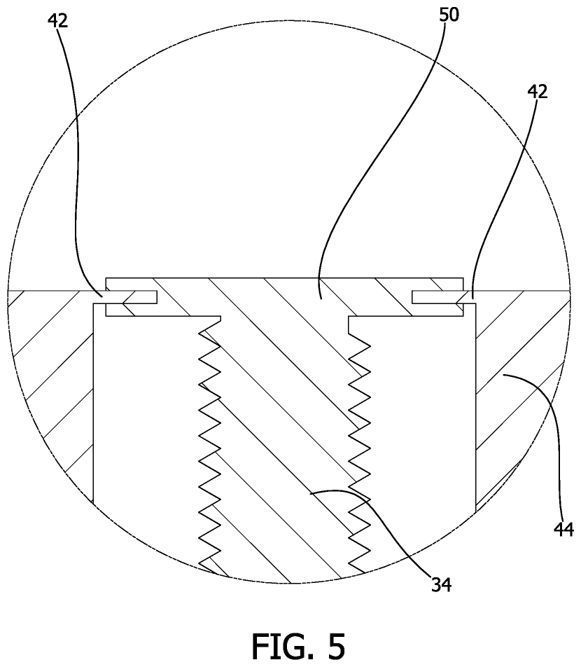

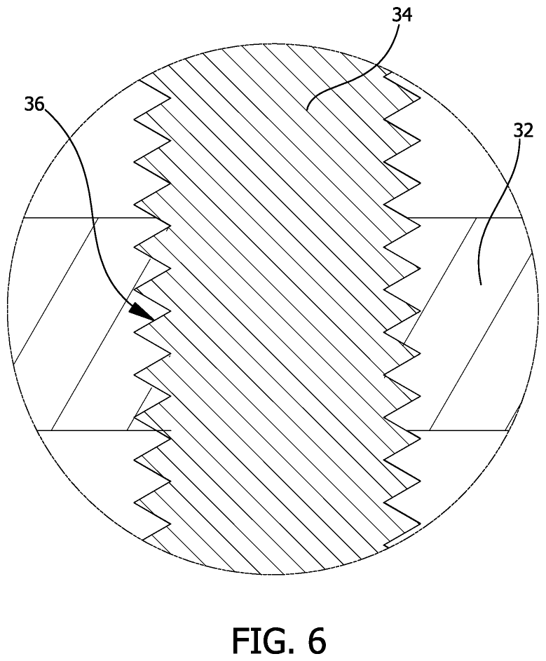

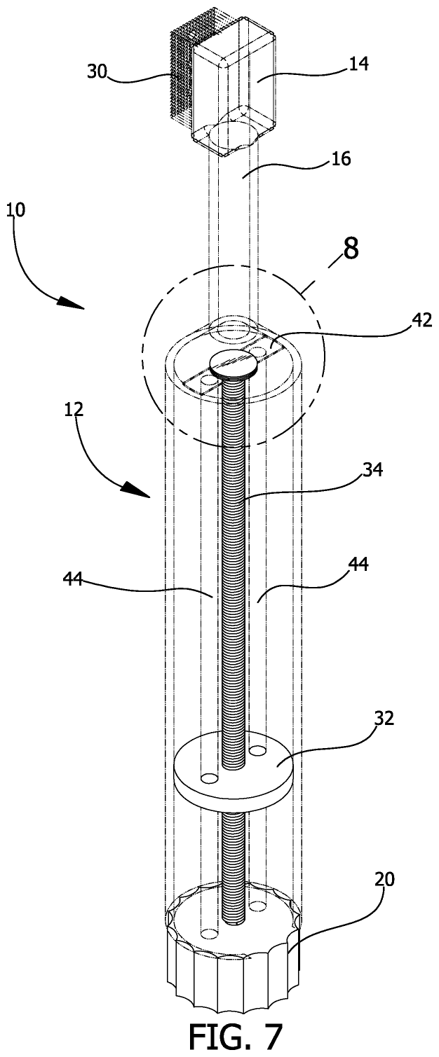

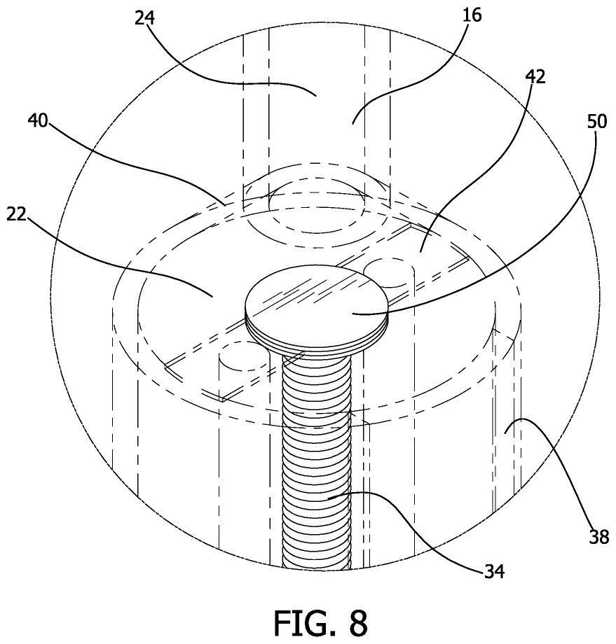

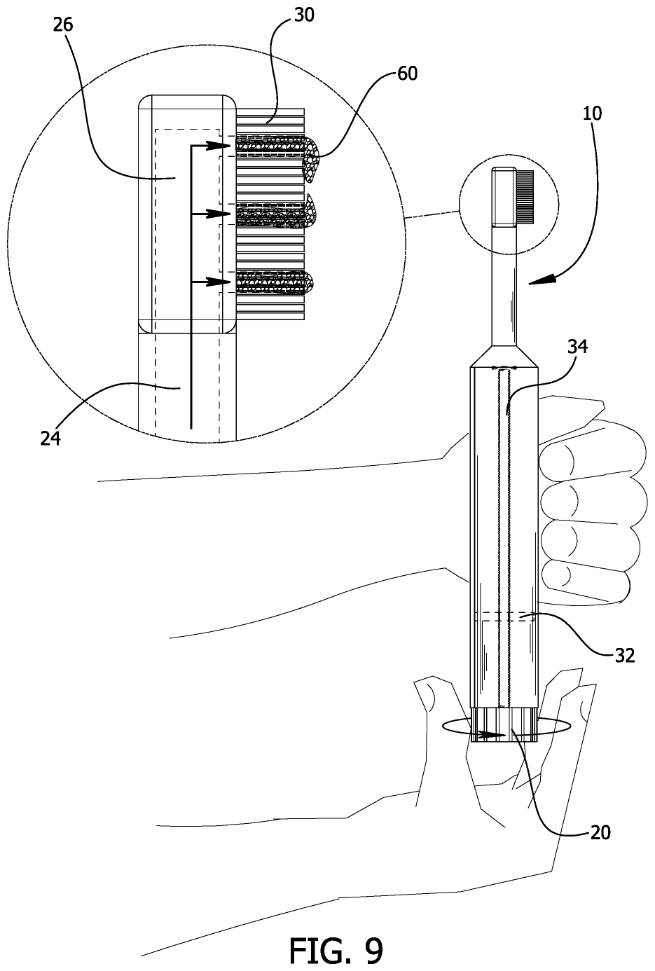

With reference now to the drawings, and in particular to FIGS. 1 through 9 thereof, a new disposable toothbrush arrangement embodying the principles and concepts of an embodiment of the disclosure and generally designated by the reference numeral 10 will be described.

As best illustrated in FIGS. 1 through 9, the disposable toothbrush arrangement 10 generally comprises A disposable toothbrush arrangement 10 includes a brush body 12, a brush head 14, a brush neck 16, a pushing arrangement 18, and a twist knob 20. The brush body 12 is designed to be gripped by a user. The brush head 14 includes bristles 30 for brushing the teeth of a user. The brush neck 16 is designed and positioned to connect the brush head 14 to the brush body 12. The brush body 12 includes a storage cavity 22 therein designed to store toothpaste 60. The brush neck 16 includes a neck channel 24 therein to permit the flow of toothpaste 60 therethrough. The brush head 14 includes a head channel 26 therein to permit the flow of toothpaste 60 into the brush head 14. The brush head 14 includes head apertures 28 operatively connected to the head channel 26 and designed and positioned to permit the flow of toothpaste 60 to the bristles 30. The pushing arrangement 18 is positioned within the brush body 12 and designed to exert a pushing force on the toothpaste 60 to thereby cause an amount of toothpaste 60 to flow out through the head apertures 28. The twist knob 20 is positioned at an end of the brush body 12 and operatively connected to the pushing arrangement 18 and designed to be twisted by a user to actuate the pushing arrangement 18.

In accordance with at least one possible embodiment, the pushing arrangement 18 includes a push plate 32 having a shape and diameter essentially equivalent to the internal shape and diameter of the storage cavity 22. The pushing arrangement 18 includes a threaded rod 34 connected to the twist knob 20. The push plate 32 includes a threaded opening 36 in the center thereof. The push plate 32 is mounted on the threaded rod 34 such that upon twisting of the twist knob 20 and the threaded rod 34 by a user the push plate 32 is advanced axially along the threaded rod 34 to exert a pushing force on toothpaste 60 in the storage cavity 22.

In accordance with at least one possible embodiment, the brush body 12 includes a cylindrical portion 38 and a conical end portion 40. The conical end portion 40 is designed and positioned to funnel toothpaste 60 into the neck channel 24.

In accordance with at least one possible embodiment, the pushing arrangement 18 includes a support band 42 mounted in the brush body 12 adjacent the conical end portion 40 and extending laterally across the storage cavity 22. The threaded rod 34 includes a first end connected to the twist knob 20 and a second end rotatably supported by the support band 42. The second end could be in the form of a disk shaped threaded rod head 50.

In accordance with at least one possible embodiment, the pushing arrangement 18 includes two guide rods 44 positioned parallel to and on opposing sides of the threaded rod 34. The push plate 32 includes two guide apertures through which pass the guide rods 44. The guide rods 44 are mounted on one end to the support band 42. The guide rods 44 are designed and positioned to support and guide the push plate 32 as it is advanced along the threaded rod 34.

In accordance with at least one possible embodiment, the brush body 12 includes a transparent side wall portion 46 to permit a user to view the amount of toothpaste 60 therein.

In accordance with at least one possible embodiment, the brush neck 16 includes a flexible resilient material to permit a user to squeeze and compress the brush neck 16 to force toothpaste 60 out through the head apertures 28.

In accordance with at least one possible embodiment, the storage cavity 22 is designed to store a supply of toothpaste 60 corresponding to a recommended amount for every day brushing over a period of time of three to six months. A protective storage cover 48 can also be included for covering the brush head when not in use.

In order to use the disposable toothbrush arrangement 10, the user twists the twist knob 20 and exerts a pressing force on the toothpaste 60 in the storage cavity 22. The user then continues twisting the twist knob 20 until a desired amount of toothpaste 60 is expelled out through the head apertures 28. The user then proceeds to brush his or her teeth. The user repeats the above steps until the push plate 32 can be advanced no further and no more toothpaste 60 can be pushed out by the push plate 32. This lets the user know the user has used up the toothpaste 60, and thus can now discard the disposable toothbrush arrangement 10.

In the embodiment where the brush neck 16 includes a flexible resilient material, the user can squeeze and compress the brush neck 16 to force any remaining toothpaste 60 out through the head apertures 28 upon the push plate 32 being unable to be advanced further to promote maximal use of the toothpaste 60. In other words, the user can make use of the last bits of toothpaste 60 in the brush neck 16 so as not to waste toothpaste 60.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A disposable toothbrush arrangement comprising:
a brush body being configured to be gripped by a user;
a brush head comprising bristles for brushing the teeth of a user;
a brush neck configured and disposed to connect said brush head to said brush body;
said brush body comprising a storage cavity therein configured to store toothpaste;
said brush neck comprising a neck channel therein to permit the flow of toothpaste therethrough;
said brush head comprising a head channel therein to permit the flow of toothpaste into said brush head;
said brush head comprising head apertures operatively connected to said head channel and configured and disposed to permit the flow of toothpaste to said bristles;
a pushing arrangement being disposed within said brush body and configured to exert a pushing force on said toothpaste to thereby cause an amount of toothpaste to flow out through said head apertures; and
a twist knob being disposed at an end of said brush body and operatively connected to said pushing arrangement and configured to be twisted by a user to actuate said pushing arrangement.

2. The disposable toothbrush arrangement of claim 1, wherein:
said pushing arrangement comprises a push plate having a shape and diameter essentially equivalent to the internal shape and diameter of said storage cavity;
said pushing arrangement comprises a threaded rod connected to said twist knob;
said push plate comprises a threaded opening in the center thereof; and
said push plate is mounted on said threaded rod such that upon twisting of said twist knob and said threaded rod by a user said push plate is advanced axially along said threaded rod to exert a pushing force on toothpaste in said storage cavity.

3. The disposable toothbrush arrangement of claim 2, wherein:
said brush body comprises a cylindrical portion and a conical end portion; and
said conical end portion is configured and disposed to funnel toothpaste into said neck channel.

4. The disposable toothbrush arrangement of claim 3, wherein:
said pushing arrangement comprises a support band mounted in said brush body adjacent said conical end portion and extending laterally across said storage cavity; and
said threaded rod comprises a first end connected to said twist knob and a second end rotatably supported by said support band.

5. The disposable toothbrush arrangement of claim 4, wherein:
said pushing arrangement comprises two guide rods disposed parallel to and on opposing sides of said threaded rod;
said push plate comprises two guide apertures through which pass said guide rods;
said guide rods are mounted on one end to said support band; and
said guide rods are configured and disposed to support and guide said push plate as it is advanced along said threaded rod.

6. The disposable toothbrush arrangement of claim 5, wherein said brush body comprises a transparent side wall portion to permit a user to view the amount of toothpaste therein.

7. The disposable toothbrush arrangement of claim 6, wherein said brush neck comprises a flexible resilient material to permit a user to squeeze and compress said brush neck to force toothpaste out through said head apertures.

8. The disposable toothbrush arrangement of claim 7, wherein said storage cavity is configured to store a supply of toothpaste corresponding to a recommended amount for every day brushing over a period of time of three to six months.

9. The disposable toothbrush arrangement of claim 1, wherein:
said brush body comprises a cylindrical portion and a conical end portion; and
said conical end portion is configured and disposed to funnel toothpaste into said neck channel.

10. The disposable toothbrush arrangement of claim 1, wherein said brush body comprises a transparent side wall portion to permit a user to view the amount of toothpaste therein.

11. The disposable toothbrush arrangement of claim 1, wherein said brush neck comprises a flexible resilient material to permit a user to squeeze and compress said brush neck to force toothpaste out through said head apertures.

12. The disposable toothbrush arrangement of claim 1, wherein said storage cavity is configured to store a supply of toothpaste corresponding to a recommended amount for every day brushing over a period of time of three to six months.

13. A method of using the disposable toothbrush arrangement of claim 1, comprising the steps of:
twisting said twist knob and exerting a pressing force on said toothpaste in said storage cavity;
continuing twisting said twist knob until a desired amount of toothpaste is expelled out through said head apertures;
brushing the teeth of a user;
repeating the above steps until said push plate can be advanced no further and no more toothpaste can be pushed out by said push plate; and
discarding said disposable toothbrush arrangement.

14. The method of claim 13, wherein said brush neck comprises a flexible resilient material, and said method further comprises squeezing and compressing said brush neck to force any remaining toothpaste out through said head apertures upon said push plate being unable to be advanced further to promote maximal use of said toothpaste.
